(19) United States
(12) Patent Application Publication
(10) Pub. No.: US 2008/0275772 A1
(43) Pub. Date: Nov. 6, 2008

(54) System and method of facilitating targeted content delivery

(75) Inventors: Lalitha Suryanarayana, Austin, TX (US); Michael Grannan, Austin, TX (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/799,740

(22) Filed: May 1, 2007

(51) Int. Cl. G06Q 30/00

(52) U.S. Cl. 705/14

(57) ABSTRACT

A method of facilitating targeted content delivery is disclosed and includes receiving a request from a third-party to deliver targeted content to a plurality of customers of a service provider, where the request includes a plurality of customer profile parameters. The method also includes aggregating profile data associated with at least some of the plurality of customers of the service provider to produce collective customer profile information corresponding to the request. The aggregated profile data matches at least some of the customer profile parameters. The method also includes communicating service terms to the third-party, wherein the service terms are determined for the request based at least partially on a type of the targeted content. Further, the method includes receiving the targeted content from the third-party after the service provider receives data indicating acceptance of the service terms.

### FIELD OF THE DISCLOSURE

The present disclosure is generally related to facilitating targeted content delivery.

### BACKGROUND

Businesses have a variety of options to deliver advertisements to potential customers. Most businesses desire to navigate these options in a way that gives them a satisfactory return on advertising expenditures and to prevent wasted advertising. Nonetheless, these goals may require merchants to dynamically target messages and advertisements to only those users that meet a specific set of criteria at a particular given instant. Public service entities may also desire to tailor dissemination of announcements in order to reach only parties that need public service information. Some services provide anonymous profiling and aggregation across users to serve targeted content. These capabilities are limited to either only the online media, or within the framework of their own website or content or limited customer base. Without the infrastructure to provide data spanning millions of subscribers, devices, networks, locations and key events instantaneously, however, such services may not be able to readily identify users that meet criteria of those desiring to distribute targeted content.

### BRIEF DESCRIPTION OF THE DRAWINGS

FIG. 1 is a block diagram of a particular embodiment of a system to facilitate targeted content delivery;

FIG. 2 is a block diagram of a second particular embodiment of a system to facilitate targeted content delivery;

FIG. 3 is a block diagram of a third particular embodiment of a system to facilitate targeted content delivery;

FIG. 4 is a flow chart of a particular embodiment of a method of facilitating targeted content delivery;

FIG. 5 is a flow chart of a second particular embodiment of a method of facilitating targeted content delivery;

FIG. 6 is a flow chart of a third particular embodiment of a method of facilitating targeted content delivery;

FIG. 7 is a flow chart of a fourth particular embodiment of a method of facilitating targeted content delivery; and

FIG. 8 is a block diagram of an illustrative embodiment of a general computer system.

### DETAILED DESCRIPTION OF THE DRAWINGS

A system to facilitate targeted content delivery is disclosed and includes a content brokering engine operable to receive a request from a third-party to deliver targeted content to a plurality of customers of a service provider, where the request includes a plurality of customer profile parameters. The content brokering engine is also operable to communicate service terms to the third-party, wherein the service terms are determined for the request based at least partially on a type of the targeted content. The content brokering engine is also operable to receive the targeted content from the third-party after the service provider receives data indicating acceptance of the service terms.

In another embodiment, a system to facilitate targeted content delivery is disclosed and includes a profile aggregation system operable to receive data from a third-party indicating a request to deliver targeted content to a plurality of customers of a service provider, where the request includes a plurality of customer profile parameters. The profile aggregation system is also operable to aggregate profile data associated with at least some of the plurality of customers of the service provider to produce collective customer profile information corresponding to the request, where the profile data matches at least some of the customer profile parameters. The profile aggregation system is also operable to communicate service terms to the third-party, where the service terms are determined for the request based at least partially on a type of the targeted content.

In another embodiment, a method of facilitating targeted content delivery is disclosed and includes receiving a request from a third-party to deliver targeted content to a plurality of customers of a service provider, where the request includes a plurality of customer profile parameters. The method also includes aggregating profile data associated with at least some of the plurality of customers of the service provider to produce collective customer profile information corresponding to the request. The aggregated profile data matches at least some of the customer profile parameters. The method also includes communicating service terms to the third-party, wherein the service terms are determined for the request based at least partially on a type of the targeted content. Further, the method includes receiving the targeted content from the third-party after the service provider receives data indicating acceptance of the service terms.

In another embodiment, a method of facilitating targeted content delivery is disclosed and includes receiving a request from a third-party to deliver targeted content to a plurality of customers of a service provider, where the request includes a plurality of customer profile parameters. The method also includes aggregating profile data associated with at least some of the plurality of customers of the service provider to produce collective customer profile information corresponding to the request. The profile data matches at least some of the customer profile parameters. The method also includes communicating service terms to the third-party, wherein the service terms are determined for the request based at least partially on a type of the targeted content. In addition, the method includes communicating delivery information to the third-party after the service provider receives data indicating acceptance of the service terms by the third-party, where the plurality of customers are accessible to the third-party using the delivery information.

In another embodiment, a method of facilitating targeted content delivery is disclosed and includes sending data to a content brokering system of a service provider. The data indicates a request to deliver targeted content to a plurality of customers of the service provider, where the request includes a plurality of customer profile parameters. The method also includes receiving data indicating a number of customers of the service provider whose profile data at least partially matches the plurality of customer profile parameters. Further, the method includes receiving service terms corresponding to the request from the service provider. In addition, the method includes sending the targeted content to the targeted content brokering system for delivery to the customers of the service provider whose profile data at least partially matches the plurality of customer profile parameters.

In another embodiment, a computer-readable medium is disclosed and includes processor-readable instructions adapted to cause a processor to execute a method comprising receiving data from a third-party indicating a request to deliver targeted content to a plurality of customers of a service provider, wherein the request includes a plurality of customer profile parameters. The method also includes aggregating profile data associated with at least some of the plurality of customers of the service provider to produce collective customer profile information corresponding to the request, where the profile data matches at least some of the customer profile parameters. The method also includes communicating service terms to the third-party, where the service terms are determined for the request based at least partially on a type of the targeted content.

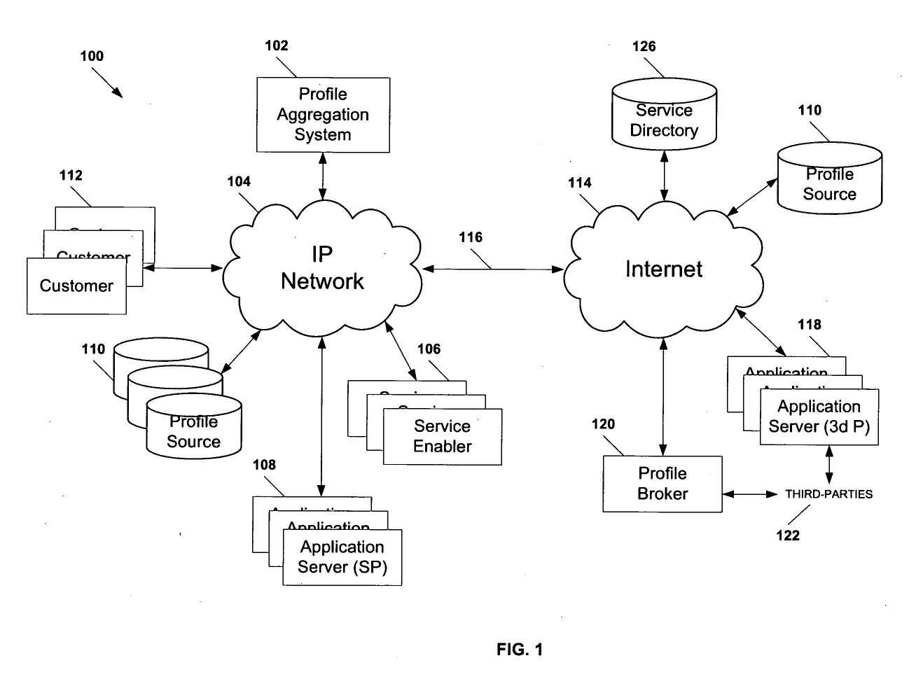

Referring to FIG. 1, a particular embodiment of a system to facilitate targeted content delivery is illustrated and designated generally 100. The system 100 includes a profile aggregation system 102 that communicates with a private Internet Protocol (IP) network 104. In a particular embodiment, the profile aggregation system 102 can be one of multiple service enabler systems 106 communicating with the private IP network 104. Each service enabler can facilitate an IP-based communication service, such as video, voice or data services, or other services such as facilitating targeted content delivery, secure network communication, or billing. In an illustrative embodiment, the service enablers 106 can include re-usable network building blocks that can be combined with different service logics to effectively yield multiple applications. Interface contracts to services provided by each service enabler 106 can be platform-independent, and the services can be dynamically located and invoked. In an illustrative, non-limiting embodiment, each service enabler 106 can be implemented using a service oriented architecture or another transaction-based billing architecture.

As shown in FIG. 1, the system 100 can include one or more service provider application servers 108 that communicate with the private IP network 104. The service provider application servers 108 can include service logic for one or more applications that are made accessible to the users 112 via the private IP network 104, to third-parties 122 via the Internet 114, or any combination thereof. Such applications may include, for example, service logic for the profile aggregation system 102 to facilitate targeted content delivery in response to third-party requests. The service provider application servers 108 can reside within a service provider domain or externally within another network environment.

In addition, the system 100 can include one or more first profile sources 110 that communicate with the private IP network 104. The profile sources 110 can store profile data associated with a plurality of users 112, such as subscribers or other customers of a service provider. The profile data can include data related to usages of IP-based services by the users 112, such as particular usages of voice services, video services and data services provided by the service provider, by one or more third-party service providers, or any combination thereof. Such particular usages can include, for example, viewing habits associated with each of the users 112 who are subscribed to an IP Television (IPTV) service; telephone numbers of incoming calls, outgoing calls, or any combination thereof, associated with each of the users 112 who are subscribed to a voice-over IP (VoIP) service, mobile telephone service, or a combination thereof; Internet surfing habits of each of the users 112 who are subscribed to an Internet service; other particular usages of voice, video or data communication services; or any combination thereof. The profile sources 110 can be distributed across domains on the private IP network 104, the Internet 114, or any combination thereof.

The private IP network 104 can communicate with the Internet 114 via a secure connection 116. In a particular embodiment, the profile aggregation system 102 can communicate with one or more third-party application servers 118, which can provide an interface for third-parties 122 to interact with the profile aggregation system 102, a profile broker system 120, or any combination thereof, to receive a service that facilitates targeted content delivery. In an illustrative, non-limiting embodiment, the profile aggregation system 102 can communicate with at least one service directory 126 to publish and advertise a service to facilitate targeted content delivery via the Internet 114.

In a particular illustrative embodiment, the profile aggregation system 102 can be operable to receive a request from a third-party 122. The request includes a request to deliver targeted content to one or more of a plurality of customers of the service provider associated with the profile aggregation system 102. In addition, the request can include a plurality of customer profile parameters specified by the third-party 122, such as parameters indicating a target audience or other target recipients of the third-party's targeted content. In a particular embodiment, one or more of the customer profile parameters can be time-based. For example, the customer profile parameters can specify customers of the service provider who watched a certain channel of an IPTV service during a previous number of days or customers who activated a cellular phone service in Austin, Tex., during the month of January.

In response to the third-party request, the profile aggregation system 102 can be operable to aggregate profile data of customers whose profile data at least partially matches the customer profile parameters specified by the third-party 122. Further, the profile aggregation system 102 can be operable to produce collective customer profile information based on the aggregated profile information. Hence, the collective customer profile information is determined on a per-request basis. The collective customer profile information can include, for example, a number of customers of the service provider whose profile data was used to produce the collective customer profile information, contact information of such customers, statistical preference information, other aggregated information, or any combination thereof.

In a particular embodiment, the collective customer profile information can be produced by mining customer profile data stored at the profile sources 110 to identify a set of customers meeting the customer profile parameters specified by the third-party 122 in the request. In an illustrative, non-limiting embodiment, the profile aggregation system 102 can determine whether any customers whose profile data matches the customer profile parameters have specified that they are unwilling to receive targeted content, such as targeted advertising content.

The profile aggregation system 102 is operable to determine service terms related to the particular request received from the third-party 122. That is, pricing and other service terms are determined on a per-request basis. In an illustrative embodiment, the service terms can be determined based at least partially on the content to be delivered and the collective customer profile information. Further, the service terms can be determined based at least partially on the number of customers of the service provider that will receive the content, the communication medium or media that will be used to deliver the content (e.g., IPTV vs. SMS), whether the service provide or the third-party will deliver the content, other factors, or any combination thereof. Service terms can include total pricing, unit pricing (e.g., per customer, per message, etc.), service level agreement terms, or any combination thereof.

In an illustrative, non-limiting embodiment, pricing and other service terms can be based at least partially on granularity and accuracy parameters received with the request. For example, the customer profile parameters received by the profile aggregation system 102 with a first request can specify that the collective customer profile information should include customers within the city of Austin, Tex., though some customer outside Austin may be included if they are within a certain television or cellular service area. Whereas, customer profile parameters received with a second request can specify that the collective customer profile information should include customers within five miles of a certain business and no other customers. Because the second request requires a more precise determination of customer locations, the granularity of the collective customer profile produced for the second request will be higher. In addition, the second request requires greater certainty by prohibiting any customers outside of the specified five-mile radius. The increased granularity and certainty requirements included with the customer profile parameters of the second request may contribute to the profile aggregation system 102 determining a higher price with respect to the second request. In an alternative embodiment, granularity and accuracy parameters can be pre-defined for the service and can be published with a listing of the service to facilitate targeted content delivery.

In some instances, the profile aggregation system 102 may produce different variations or views of profile data associated with a same set of customers. Hence, collective customer profile information produced in response to different requests can be used for different applications, despite being produced using the same customer profile data. Moreover, different pricing and other service terms can be applied to each request, though the collective customer profile information produced for each request is based on the same customer profile data.

In an illustrative embodiment, the profile aggregation system 102 can be operable to send data related to collective customer profile information to the third-party 122. For instance, the third-party 122 may be unable to determine whether it should accept the service terms before knowing how many customers are likely to receive the targeted content. The data related to the collective customer profile information can indicate a number of customers whose profile data was aggregated to produce the collective customer profile information. The profile aggregation system 102 can be operable to send such data to the third-party 122 with the service terms, prior to the service terms, after the service terms, in response to a request from the third-party 122 for such data, or any combination thereof.

In a particular embodiment, the third-party 122 can send data to the service provider indicating an acceptance of the service terms that have been determined for the specific request. The profile aggregation system 102 can be operable to receive such acceptance data from the third-party 122 or to receive an indication of acceptance from another service provider system that receives the acceptance data from the third-party 122. For instance, the acceptance can include payment of a price, and a billing system can send data indicating the payment to the profile aggregation system 102. After acceptance of the service terms by the third-party 122, the profile aggregation system 102 can be operable to perform various functions. For example, the third-party 122 can deliver the targeted content to the customers whose profile data was aggregated to produce the collective customer profile information. The profile aggregation system 102 can be operable to send delivery information to the third-party 122, directly or via the profile broker 120, after the service provider has received data indicating acceptance of the service terms. The delivery information can include contact information of the customers to whom the content will be sent or information that the third-party can use to deliver the content via the service provider communication service systems without receiving personal information of the customers (e.g., via a content delivery broker).

In another example, the service provider can deliver the targeted content, and the profile aggregation system 102 can be operable to receive the content from the third-party 122 after acceptance of the service terms. Further, the profile aggregation system 102 can be operable to send the content to one or more network elements that are adapted to deliver content to customers, such as video servers, short message service (SMS) network elements, e-mail servers, other network elements, or any combination thereof. In this way, no profile data of any customer is disclosed to the third-party 122. In a particular embodiment, the profile aggregation system 102 can be operable to determine whether the content includes separate portions, such as a video portion, and audio portion, a text portion, or any combination thereof. The profile aggregation system 102 can be operable to send the first portion to a first type of network element (e.g., a video server) and the second portion to a second type of network element (e.g., an e-mail or SMS network element).

In an illustrative example, the third-party 122 can be a car dealership that sends a request to the profile aggregation system 102 to deliver targeted content, such as a text message, to a plurality of customers of a service provider associated with the profile aggregation system 102. The request can include customer profile parameters that specify that collective customer profile information produced for the request should include aggregated profile data of all customers of the service provider who have a Cingular phone operable to receive text messages; who are currently within a five mile radius of the car dealership; and who viewed a television program during which the car dealership's ad appeared within the previous twenty-four hours. The car dealership may specify a granularity of the customer location, such that customers outside the five mile radius but within range of a cell tower providing service to those within the five mile radius, for instance, may satisfy the customer profile parameters.

The profile aggregation system 102 can receive the request with the customer profile parameters and determine service terms corresponding to the request. For example, the profile aggregation system 102 can determine pricing based on the type of content to be delivered, an amount of content (e.g., a character length), the granularity specified by the car dealership, other factors, or any combination thereof. The price may be expressed as a per customer or per text message price. Service terms may also include a service level agreement (SLA). The profile aggregation system 102 can send data indicating the service terms to the car dealership.

In addition, the profile aggregation system 102 can mine customer data stored at the profile sources 110 to find customer profile data that meets the customer profile parameters. For instance, the profile aggregation system 102 can determine which customers meet the location parameter and then check profile data associated with those customers to determine whether the customer have an IPTV subscription and which of those customers watched the specified television program(s) during the previous twenty-four hours. The profile aggregation system 102 may also check profile data indicating whether each of the customers is willing to receive SMS advertisements.

The profile aggregation system 102 aggregates the profile data of the customers meeting the customer profile parameters specified by the car dealership to produce collective customer profile information. The profile aggregation system 102 can send a number of such customers to the car dealership. If the car dealership is satisfied with the number of customers and the service terms, the car dealership can send data indicating acceptance of the service terms to the profile aggregation system 102 or another system of the service provider. Additionally, where the service provider is to deliver the SMS message to the customers, the profile aggregation system 102 can receive the text of the SMS message from the car dealership and deliver the message or send it to another service provider system that delivers the message. The message could read, for example, “Did u see Brown Chevrolet's ad during ER last night? Show us this text on your phone today, and we'll give you $50 for test driving a Tahoe!”

In another illustrative example, a telecommunications provider can provide a service that combines messages from multiple phones into one voice mail box and notifies users by cell phone any time a message is received. The telecommunications provider can send a request to the profile aggregation system 102 to deliver targeted upsell content to customers of the service provider. Customer profile parameters included in the request can specify all cell phone customers within a specific metropolitan area who receive a voice mail message on their home phone over the next twenty-four hours and who do not already subscribe to the combined voice mail box service. The profile aggregation system 102 can determine service terms for delivery of voice mail from the home phones to the cell phones of such customers with an introductory message advertising the combined voice mail box service. Because the time basis of the customer profile parameters ends at a future time, pricing can be set at a single inclusive fee. Alternatively, the pricing can be expressed as a per customer charge. In another embodiment, the telecommunications provider can be the core operator of the private IP network, such as a division, affiliate, or contractor of the service provider, in which case the profile aggregation system 102 can determine that no price is to be charged.

The profile aggregation system 102 can mine customer data stored at the profile sources 110 to find customer profile data that meets the customer profile parameters. For instance, the profile aggregation system 102 can aggregate profile data of customers receiving voice mail messages according to the customer profile parameters every hour over a twenty-four hour period and deliver the targeted content to those customers. In this example, the profile aggregation system 102 may also store data associated with each of the customers who have received the targeted content to prevent reiteration.

In yet another illustrative example, the third-party can be a public entity, such as a government agency, a schooling entity, an emergency alert entity, a weather service, news agency, or other public entity. The public entity can send a request to the profile aggregation system 102 to deliver targeted emergency content or other public service content to customers of the service provider, such as customers that live in a certain county or within a certain distance of a location of a Doppler-indicated tornado. Service terms can be pre-defined between the service provider and the public entity, such that time is not consumed by a service terms acceptance process during an active emergency. The profile aggregation system 102 can aggregate profile data of customers meeting the customer profile parameters, and, if a minimum number of such customers are found, the profile aggregation system 102 can receive the targeted emergency content. The service provider can deliver the content to the customers via an IPTV service.

In a further illustrative example, the third-party can be a video source entity, such as a sports broadcasting entity. The video source entity can send a request to the profile aggregation system 102 to deliver targeted video content of a sports contest to customers of the service provider, such as customers that live in a city associated with a new sports team, in order to promote ticket sales for future contests. Service terms can be determined for the request based on the number of customers served, the duration of the content, or other factors. The profile aggregation system 102 can aggregate profile data of customers meeting the customer profile parameters, and the profile aggregation system 102 can receive the targeted video content after the service terms are accepted. The service provider can deliver the content to the customers via an IPTV service.

Those skilled in the art will appreciate that other parties and types of content are within the scope of this disclosure. For example, some third parties may include customers of the service provider and localized content can be shared with other customers. For example, a customer can send a request to the profile aggregation system 102 to send an e-mail to customers of the service provider who live in a certain zip code or neighborhood informing such customers of various events, such as garage sales, a canceled school sporting event, neighborhood meetings, or other events. Hence, the service could provide centralized communication among groups of customers that would otherwise have to contact each other individually.

The implementation of the profile aggregation system 102 and interfaces to third party applications can be technology and operating system-independent, such that a variety of infrastructures can be used to publish, invoke and support the service to facilitate targeted content delivery with security, handshaking, and other functions. For instance, a Web Services infrastructure can be employed, in which a universal description discovery and integration (UDDI) registry is used to list a service to facilitate targeted content delivery on the Internet 114 and to provide an interface that responds to Service Oriented Architecture Protocol (SOAP) messages requesting invocation of the service. In another example, an infrastructure using Parlay X application programming interfaces (APIs) can be employed to support the service via the Internet 114. Alternatively, the infrastructure used to implement and support the service can include session initiation protocol (SIP) application servers and Web servers and can employ a Lightweight Directory Access Protocol (LDAP) type directory for classification, publishing and lookup of the service. Further, a call session control function (CSCF) network element in an IP multimedia subsystem (IMS) infrastructure can provide service control for composition and orchestration of the subsequent service logic. Other elements such as open service access (OSA) elements can enable orchestration, policy enforcement and billing with regards to the profile aggregation system 102, other service enablers 106, or any combination thereof. The final application that provides the service to facilitate targeted content delivery by leveraging aggregated profile data (with security, billing, SLA, and other managed capabilities implemented by the infrastructure) can reside at the service provider application servers 108 within the service provider domain within an external environment.

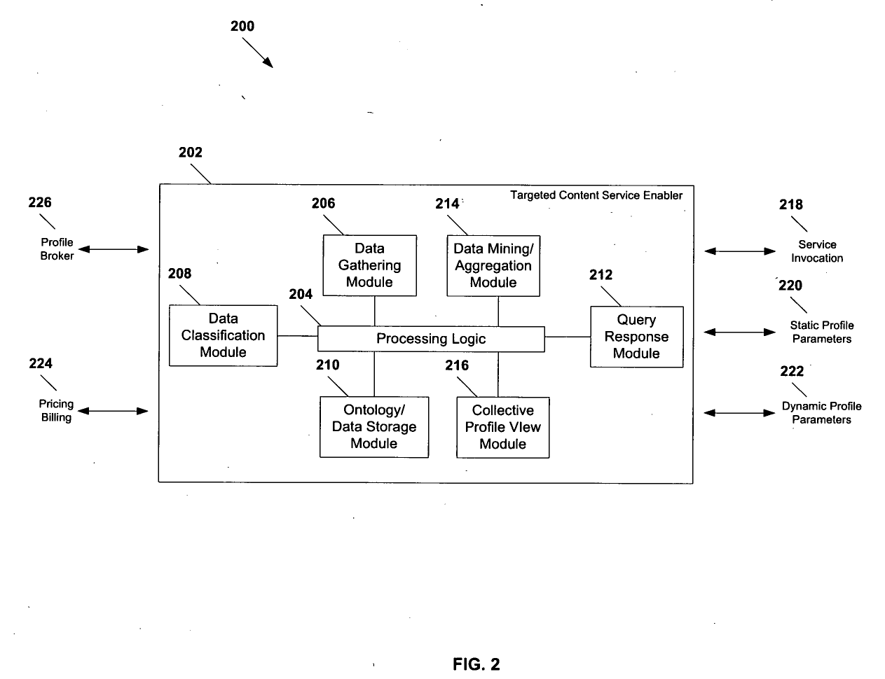

Referring to FIG. 2, a second particular embodiment of a system to facilitate targeted content delivery is illustrated and designated generally 200. The system 200 includes a targeted content service enabler 202 having processing logic 204 and a plurality of modules 206-216 that are accessible to the processing logic 204. Though the modules 206-216 are described with reference to executable instructions, the modules 206-216 can include executable instructions, hardware logic, or any combination thereof.

In a particular embodiment, the targeted content service enabler 202 can include a data gathering module 206 that is executable by the processing logic 204 to gather data regarding usage of a plurality of communication services by customers of a service provider associated with the targeted content service enabler 202. For example, the data gathering module 206 can be executable by the processing logic 204 to gather data related to customers' Internet Protocol Television IPTV viewing histories; voice communication histories, such as Voice-over Internet Protocol (VoIP) and cellular usage; Internet histories or other data network interface usage; or any combination thereof.

In an illustrative embodiment, the targeted content service enabler 202 can include a data classification module 208 that is executable by the processing logic 204 to classify semantic information regarding customer profiles into logical relationships stored as ontologies. These ontologies can link to data values or hyperlink to profile sources, such as the profile sources 110 illustrated in FIG. 1, via uniform resource indicators (URIs) that point to data values indirectly. The ontologies can be queried via extensible markup language (XML) queries or other protocols. The data and ontologies can be stored and at an ontology/data storage module 210.

Further, the targeted content service enabler 202 can include a query response module 212 that is executable by the processing logic 204 to receive a service invocation 218 from a third-party to deliver targeted content to customers of the service provider. The request can include customer profile parameters that specify which customers of the service provider are to receive the targeted content. The customer profile parameters can include static profile parameters 220, such as all customers living within a geographic area or all customers subscribing to a cellular service; dynamic profile parameters 222, such as customers tuned to a particular channel during a specified past or future time period; or any combination thereof.

The query response module 212 can also be executable by the processing logic 214 to communicate service terms related to the particular request to the requesting party. The service terms can be determined based on the type of targeted content to be delivered, as well as other factors, such as a number of customers that are to receive the targeted content, a duration of the targeted content, such as the length of an IPTV advertisement, a transmission time when the targeted content is to be delivered (e.g., peak cellular hours, during a hit television program, etc.), other factors, or any combination thereof. The service terms can include pricing, service level agreements, or any combination thereof. In the embodiment shown in FIG. 2, the service terms, such as pricing and billing terms 224 can be received at the targeted content service enabler 202 from a negotiation system or other network component. In another embodiment, the targeted content service enabler 202 can determine service terms for each request.

In a particular embodiment, the targeted content service enabler 202 can include a data mining/aggregation module 214 that is executable by the processing logic 204 to find and aggregate profile data of customers whose profile data at least partially matches the customer profile parameters specified by the requesting party. In an illustrative, non-limiting embodiment, the targeted content service enabler 202 can include a collective profile view module 216 that is executable by the processing logic 204 to produce collective customer profile information from the aggregated profile data, where the collective customer profile data corresponds to the particular request and provides a view of the profile data that that at least partially enables the requesting party to evaluate whether to accept service terms corresponding to the request. For instance, view of the profile data can allow the requesting party to evaluate whether a sufficient number of customers are associated with profile data that at least partially matches the customer profile parameters, without disclosing any personal information of such customers.

In one embodiment, data can be aggregated and a collective customer profile can be produced prior to the determination of service terms. For example, where pricing is based at least partially on a number of customers who will receive targeted content, pricing can be determined after the collective customer profile is produced. In other embodiments, pricing and other service terms may be determined prior to data aggregation, for instance, where pricing is not based on how many customers will receive targeted content.

In a particular embodiment, the targeted content service enabler 202 can send the collective customer profile information produced from the aggregated profile data to a profile broker 226. The profile broker 226 can communicate data related to the collective customer profile information, such as a number of customers whose profile data at least partially matches the customer profile parameters, to the requesting party. In an illustrative, non-limiting embodiment, the profile broker 226 can receive the targeted content once the requesting party has accepted the service terms. The profile broker 226 can send the targeted content to delivery systems of the service provider associated with the targeted content service enabler 202, such as an IPTV system, one or more voice communication networks, a data network, or any combination thereof, for delivery to customers whose profile data was aggregated to produce the collective customer profile information.

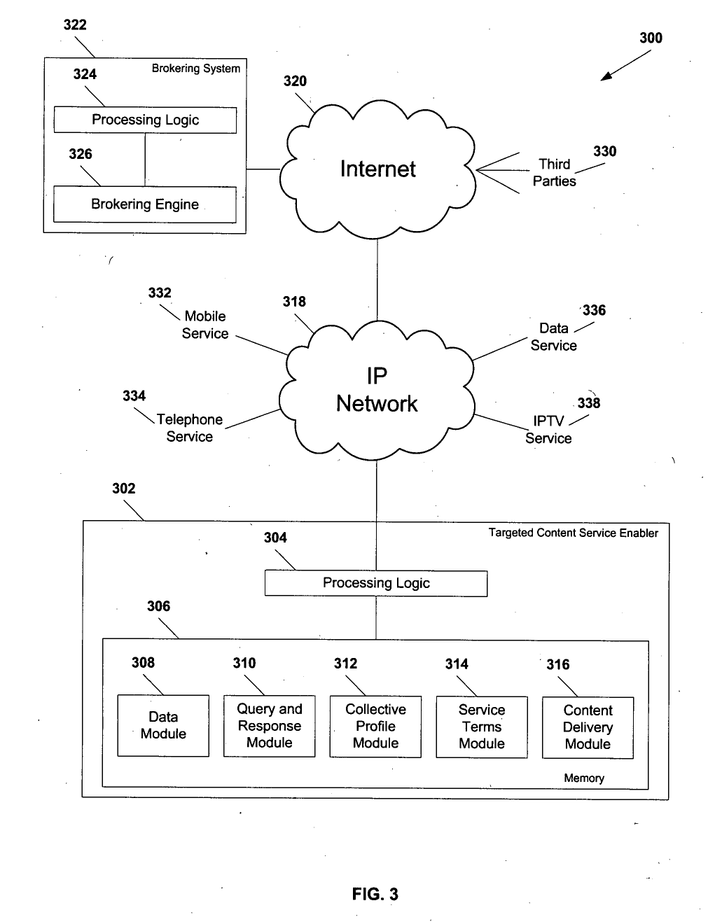

Referring to FIG. 3, a third particular embodiment of a system to facilitate targeted content delivery is illustrated and designated generally 300. The system 300 includes a targeted content service enabler 302 that communicates with a brokering system 322 via a secure connection between a private Internet protocol (IP) network 318 and the Internet 320. In a particular embodiment, the private IP network 318 can be maintained by a service provider associated with the targeted content service enabler 302 and the brokering system 322. The targeted content service enabler 302 can communicate via the private IP network 318 with one or more communication service systems of the service provider, such as systems to provide mobile phone service 332, telephone service 334, data service 336 (e.g., Internet access, e-mail, etc.), IPTV service 338, or any combination thereof. Third-parties 330 can communicate with the brokering system 322 via the Internet 320 using, for example, third-party application interfaces.

In a particular embodiment, the brokering system 322 can include processing logic 324 and a brokering engine 326 accessible to the processing logic 324. The brokering engine 326 can include hardware logic, processor-executable instructions, or any combination thereof, operable to perform various functions related to facilitating targeted content delivery. For example, the brokering engine 326 can be operable to receive a request from a third-party to deliver content to a plurality of customers of the service provider, where the request includes a plurality of customer profile parameters. The brokering engine 326 can be operable to communicate the request to the targeted content service enabler 302 and to receive service terms determined for the request from the targeted content service enabler 302. The brokering engine 326 can be operable to communicate the service terms to the third-party from whom the request was received. The brokering engine 326 can also be operable to communicate data related to collective customer profile information produced by the targeted content service enabler 302 to the third-party. The brokering engine 326 can receive such data from the targeted content service enabler 302, or the brokering engine 326 can receive the collective customer profile information and produce the related data.

In a particular embodiment, the brokering engine 326 can be operable to receive the targeted content from the third-party after the service provider receives data indicating acceptance of the service terms. For instance, the targeted content service enabler 302 can receiving an indication that the service terms have been accepted and can notify the brokering engine 326 of such acceptance. The brokering engine 326 can be operable to prompt the third-party to send the targeted content to the brokering engine 326, and the brokering engine 326 can be operable to forward the content to one or more of the communication service systems 332-338 for delivery to customers whose profile data at least partially matches customer profile parameters included with the request sent by the third-party. In an illustrative embodiment, the brokering engine 326 can be operable to determine that the targeted content has multiple portions of different types. The brokering engine 326 can be operable to send portions of different types to different communication service systems, such as a video portion to a system associated with the IPTV service 338 and a text portion to a system associated with a mobile service 332 or a data service 336. In another embodiment, the brokering engine 326 can be operable to forward the targeted content to the targeted content service enabler 302.

The targeted content service enabler 302 includes processing logic 304 and memory 306. The memory can include a data module 308 that is executable by the processing logic 304 to gather and store data regarding usage of the plurality of communication services 332-338 by customers of the service provider associated with the targeted content service enabler 302. The data module 308 can also be executable by the processing logic 304 to classify the data, and to store ontologies and individual customer profiles that are based on the gathered data.

Further, the targeted content service enabler 302 can include a query response module 310 that is executable by the processing logic 304 to receive data from the brokering system 322 indicating a third-party request to deliver targeted content. The query response module 3 10 can also be executable by the processing logic 304 to communicate service terms, collective customer profile information, data related to collective customer profile information, or any combination thereof, which the targeted content service enabler 302 determines for the particular request, to the brokering system 322.

In a particular embodiment, the targeted content service enabler 302 can include a collective profile module 312 that is executable by the processing logic 304 to find and aggregate profile data of customers whose profile data at least partially matches customer profile parameters specified in a particular request received from the brokering system 322. The collective profile module 312 can be executable by the processing logic 304 to produce collective customer profile information from the aggregated profile data, where the collective customer profile data corresponds to the particular request and provides a view of the profile data that at least partially enables the requesting party to evaluate whether to accept service terms corresponding to the request.

In a particular embodiment, the targeted content service enabler 302 can include a service terms module 314 that is executable by the processing logic 304 to determine service terms for a particular request, such as pricing and service level agreement terms, and to send data indicating the service terms to the brokering system 322. The service terms module 314 can be executable by the processing logic 304 to determine the service terms based on the type of targeted content to be delivered to customers of the service provider, whether the service provider or the third-party is to deliver the content, an amount or duration of the targeted content, a communication service(s) needed to deliver the targeted content, a number of customers that will receive the content, a transmission time during which the content is to be delivered, a granularity parameter specified in the request, a certainty parameter specified in the request, other factors, or any combination thereof.

In one embodiment, data can be aggregated and a collective customer profile can be produced prior to the determination of service terms. In other embodiments, pricing and other service terms may be determined prior to data aggregation.

In a particular embodiment, the targeted content service enabler 302 can include a content delivery module 316 that is executable by the processing logic 304 to receive targeted content from a third-party via the brokering system 322 and to send the content to one or more of the service provider communication systems 332-338 for delivery to customers of the service provider whose profile data at least partially matches customer profile parameters included with the request sent by the third-party. The content delivery module 316 can also be executable by the processing logic 304 to receive third-party instructions related to delivery of the content, such as a time of day at which the content is to be delivered, television channels at which the content is to be delivered, television programming during which the content is to be delivered, or other instructions. In one embodiment, the content delivery module 316 can be executable by the processing logic 304 to determine that the targeted content has multiple portions of different types and to send portions of different types to different communication service systems.

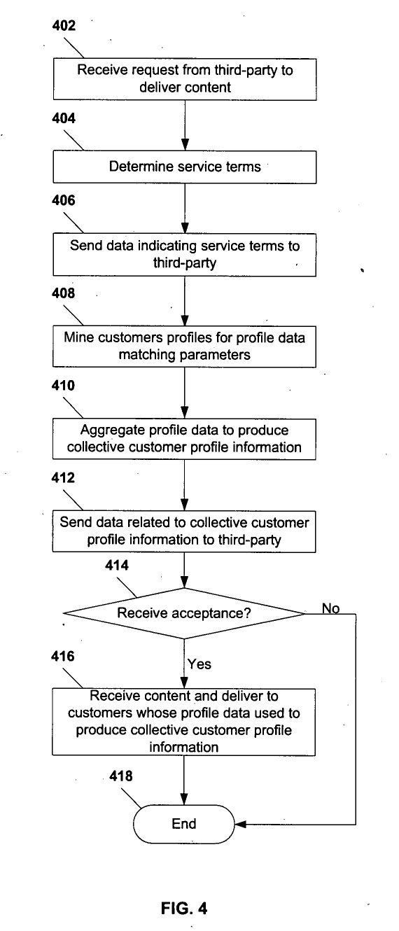

Referring to FIG. 4, a particular embodiment of a method of facilitating targeted content delivery is illustrated. At block 402, a request to deliver content to customers of a service provider is received from a third-party at a system associated with the service provider. The request includes customer profile parameters that specify characteristics of intended or target recipients. Such parameters can be static, dynamic, or any combination thereof. In a particular embodiment, the request can include other elements, such as whether the third-party or the service provider will deliver the targeted content, a type of content (e.g., text, video, audio, e-mail), a subject matter of the content (e.g., advertisement, public service, upsell, emergency) an amount or duration of content (e.g., a text character length or commercial duration), a time at which the content is to be delivered (e.g., peak time, during prime time television programming), other factors, such as granularity and certainty of the customer profile parameters, or any combination thereof.

Moving to block 404, the service provider system can determine service terms for the request, such as a price to be charged by the service provider to deliver the targeted content to customers matching the customer profile parameters specified in the request. The service terms can also include a service level agreement related to such delivery. The service terms are determined for the particular request based on the type of targeted content to be delivered to customers of the service provider, other elements or parameters include with the request, factors independent of the request, or any combination thereof. Proceeding to block 406, the service provider sends data indicating the service terms to the third-party.

Continuing to block 408, the service provider mines customer profiles across multiple communication services and other sources for profile data matching the customer profile parameters specified in the particular request. Advancing to block 410, the service provider system aggregates the profile data to produce collective customer profile information for the particular request. At block 412, in an illustrative embodiment, the service provider system can send data related to the collective customer profile information to the third-party. The data related to the collective customer profile information can indicate, for example, a number of customers whose profile data was aggregated to produce the collective customer profile information.

Moving to block 414, the service provider system determines whether it has received data from the third-party or another system associated with the service provider, indicating acceptance of the service terms by the third-party. If the service provider determines that the third-party has accepted the service terms, the method proceeds to block 416, and the service provider system receives the content from the third-party and delivers the content to the customers whose profile data was used to produce the collective customer profile information. The service provider system can deliver the content directly to customer communication devices or can forward the content to one or more service provider communication service systems for delivery to the customers. The method terminates at 418.

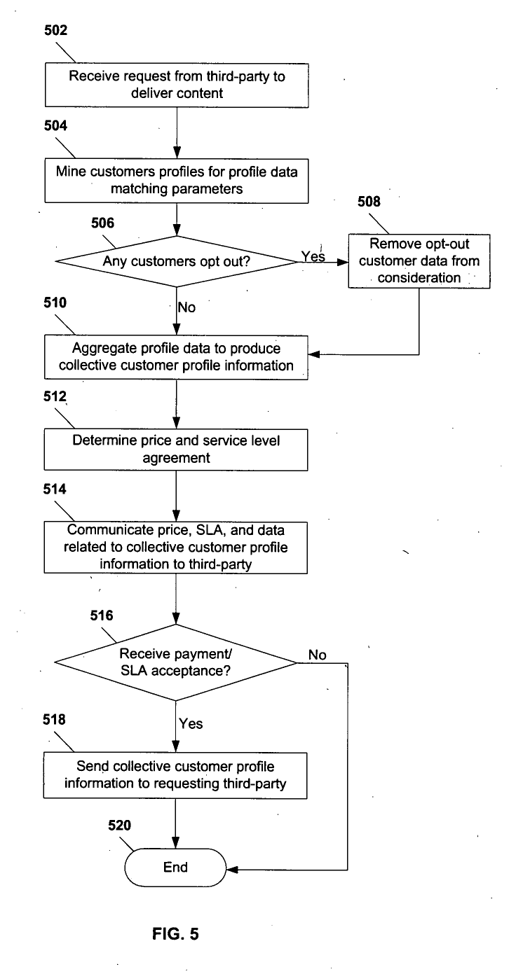

Referring to FIG. 5, a second particular embodiment of a method of facilitating targeted content delivery is illustrated. At block 502, a request to deliver content to customers of a service provider is received from a third-party at a system associated with the service provider. The request includes customer profile parameters that specify characteristics of intended or target recipients. Such parameters can be static, dynamic, or any combination thereof. The request can also include granularity and certainty parameters that specify how precisely and accurately aggregated profile data is to satisfy the customer profile parameters.

Moving to block 504, the service provider mines customer profiles across multiple communication services and other sources for profile data matching the customer profile parameters specified in the particular request. Proceeding to decision node 506, the service provider can determine whether profile data of any of the customers indicates an option to not receive targeted advertising. For example, the profile data associated with one or more customers can indicate selection of an opt-out preference. Profile data associated with customers who have opted out of receiving targeted advertising can be removed from consideration by the service provider system. Continuing to block 508, the service provider system aggregates the profile data of remaining customers whose profile data at least partially matches the customer profile parameters of the particular request, producing collective customer profile information for the particular request.

Advancing to block 510, the service provider system can determine service terms for the request, such as a price to be charged by the service provider to deliver the targeted content to customers matching the customer profile parameters specified in the request. The service terms can also include a service level agreement related to such delivery. The service terms are determined for the particular request based on the type of targeted content to be delivered to customers of the service provider, whether the service provider or the third-party is to deliver the content, an amount or duration of the targeted content, a communication service(s) needed to deliver the targeted content, a number of customers that will receive the content, a transmission time during which the content is to be delivered, a granularity parameter specified in the request, a certainty parameter specified in the request, other factors, or any combination thereof.

At block 512, the service provider system sends data indicating the pricing and service level agreement (SLA) to the third-party. In an illustrative embodiment, the service provider system can send data related to the collective customer profile information to the third-party. The data related to the collective customer profile information can indicate, for example, a number of customers whose profile data was aggregated to produce the collective customer profile information.

Moving to block 516, the service provider system determines whether it has received data from the third-party or another system associated with the service provider, indicating acceptance of the service terms by the third-party. If the service provider determines that the third-party has accepted the service terms, the method proceeds to block 518, and the service provider system sends delivery information to the third-party. The delivery information can include, for example, contact information of the customers whose profile was used to produce the collective customer profile information or information to enable the third-party to deliver the content to customers via one or more of the service provider communication service systems without disclosing personal information of the customers to the third-party. The method terminates at 520.

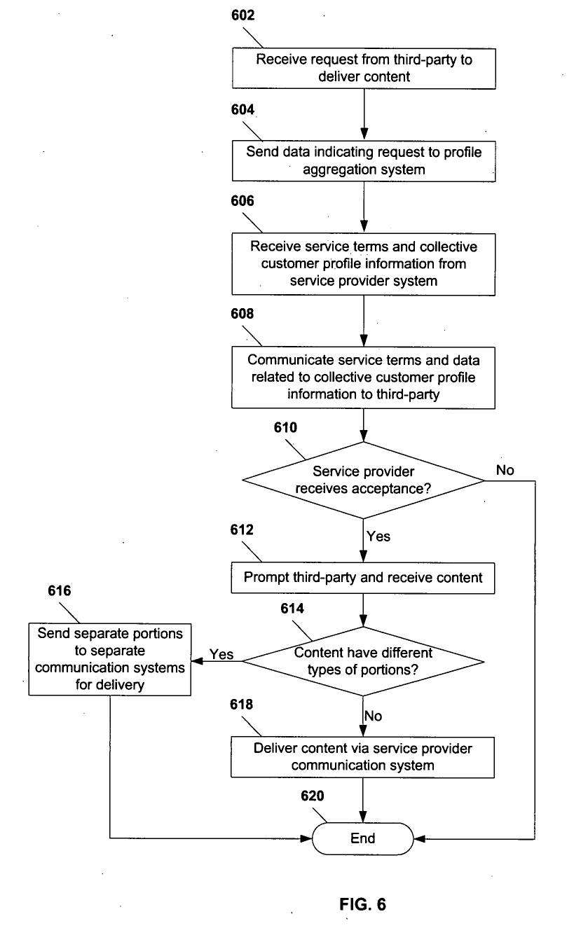

Referring to FIG. 6, a third particular embodiment of a method of facilitating targeted content delivery is illustrated. At block 602, a request to deliver content to customers of a service provider is received from a third-party at a brokering system. The request includes customer profile parameters that specify characteristics of intended or target recipients. Such parameters can be static, dynamic, or any combination thereof. Moving to block 604, the brokering system sends data indicating the request to a targeted content delivery service enabler of a service provider.

Proceeding to block 606, the brokering system receives service terms determined for the particular request and data related to collective customer profile information produced for the particular request. Continuing to block 608, the brokering system communicates the service terms and data related to the collective customer profile information to the third-party. Advancing to decision node 610, the brokering system can determine whether service provider has received acceptance of the service terms from the third-party. The acceptance can be received from the third-party at the brokering system, or another system of the service provider can inform the brokering system of an acceptance, such as the electronic payment of a price associated with the service terms. If the brokering system determines that the third-party has not accepted the service terms, the method can terminate at 620.

Conversely, if the brokering system determines that the service provider has received an acceptance of the service terms from the third-party, the method proceeds to block 612. At block 612, in a particular embodiment, the brokering system can prompt the third-party for the targeted content to be delivered to certain customers of the service provider, and the brokering system can receive the content. Moving to decision node 614, in an illustrative embodiment, the brokering system can determine whether the content includes portions having different types. If the content includes portions having different types, such as a video portion and a text portion, the method proceeds to block 616, and the brokering system can send the separate portions to separate communication systems of the service provider for delivery. On the other hand, if the content does not includes portion having different types, the brokering system can deliver the content via a single service provider communication system. The method terminates at 620.

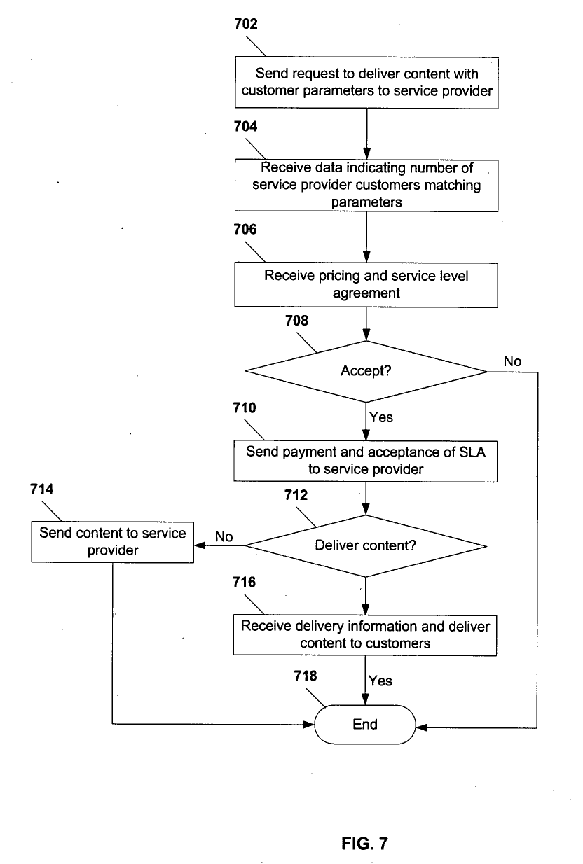

Referring to FIG. 7, a fourth particular embodiment of a method of facilitating targeted content delivery is illustrated., At block 702, a party sends a request to deliver content to customers of a service provider to a service provider system. The request includes customer profile parameters that specify characteristics of intended or target recipients. Such parameters can be static, dynamic, or any combination thereof, and can include granularity and certainty parameters. The request can be sent to a targeted content delivery service enabler or brokering system of the service provider.

Moving to block 704, the requesting party receives data indicating a number of service provider customers matching the customer profile parameters. Proceeding to block 706, the requesting party receives service terms from the service provider for delivery of the targeted content, such as pricing and service level agreement terms. Continuing to decision node 708, the requesting party can determine whether to accept the service terms. If the requesting party does not accept the service terms, the method can terminate at 718. Conversely, if the requesting party accepts the service terms, the method proceeds to block 710, and the requesting party can send data indicating such acceptance, such as payment and acceptance of a service level agreement, to the service provider.

At decision node 712, the requesting party can determine whether the party or the service provider is to deliver the targeted content. In one embodiment, data indicating whether the party or the service provider is to deliver the content can be included with the request. If the service provider is to deliver the content, the party can send the content to the service provider system. Whereas, if the requesting party is to deliver the content, the party can receive delivery information from the service provider and deliver the targeted content using the delivery information. The method terminates at 718.

It will be appreciated by those skilled in the art that the methods can be performed as described, or certain aspects of the methods can be performed in various sequences or simultaneously, without departing from the scope of the invention.

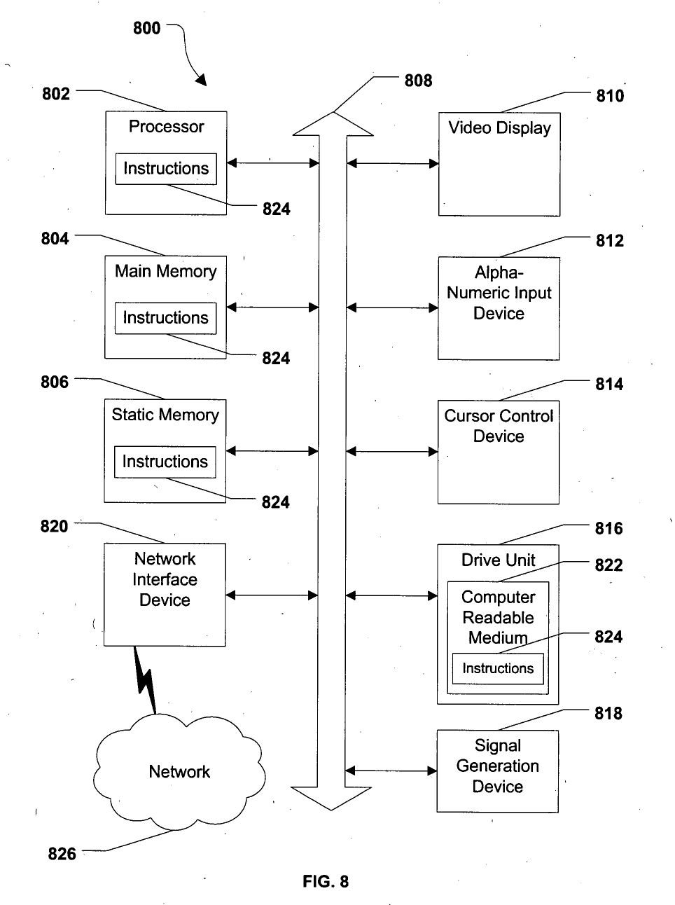

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices, such as a profile aggregation system, a targeted content delivery service enabler, a brokering system, a third-party system, or other systems illustrated in FIGS. 1-3.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of facilitating targeted content delivery, the method comprising:
receiving a request from a third-party to deliver targeted content to a plurality of customers of a service provider, wherein the request includes a plurality of customer profile parameters;
communicating service terms to the third-party, wherein the service terms are determined for the request based at least partially on a type of the targeted content;
aggregating profile data associated with at least some of the plurality of customers of the service provider to produce collective customer profile information corresponding to the request, wherein the aggregated profile data matches at least some of the customer profile parameters; and
receiving the targeted content from the third-party after the service provider receives data indicating acceptance of the service terms.

2. The method of claim 1, further comprising communicating data related to the collective customer profile information to the third-party before receiving the targeted content from the third-party.

3. The method of claim 2, wherein the data related to the collective customer profile information indicates a number of customers of the service provider whose profile data was used to produce the collective customer profile data.

4. The method of claim 3, wherein the service terms are based at least partially on the number of customers.

5. The method of claim 1, wherein the service terms are based at least partially on a subject matter of the targeted content, whether the service provider or the third-party is to deliver the targeted content, an amount of the targeted content, a duration of the targeted content, one or more communication services required to deliver the targeted content, a number of customers that will receive the targeted content, a transmission time during which the targeted content is to be delivered, a granularity parameter specified in the request, a certainty parameter specified in the request, or any combination thereof.

6. The method of claim 1, further comprising delivering the targeted content to customers whose profile data was used to produce the collective customer profile data.

7. The method of claim 6, wherein the request includes an instruction to deliver the targeted content on behalf of the third-party.

8. The method of claim 6, further comprising sending the targeted content to an Internet Protocol Television (IPTV) delivery system, a short-range messaging service (SMS) delivery system, a voice communication system, a data network delivery system, or any combination thereof.

9. The method of claim 6, wherein the targeted content includes at least two of a visual portion, a text portion, and an audio portion, and wherein the targeted content is delivered by the service provider via at least two of an Internet Protocol Television (IPTV) network, a short-range messaging service (SMS), a voice communication network, and a data network.

10. The method of claim 1, further comprising prompting the third-party to send the targeted content after the service provider receives data indicating acceptance of the service terms.

11. A method of facilitating targeted content delivery, the method comprising:
receiving a request from a third-party to deliver targeted content to a plurality of customers of a service provider, wherein the request includes a plurality of customer profile parameters;
aggregating profile data associated with at least some of the plurality of customers of the service provider to produce collective customer profile information corresponding to the request, wherein the profile data matches at least some of the customer profile parameters;
communicating service terms to the third-party, wherein the service terms are determined for the request based at least partially on a type of the targeted content; and
communicating delivery information to the third-party after the service provider receives data indicating acceptance of the service terms by the third-party, wherein the plurality of customers are accessible to the third-party using the delivery information.

12. The method of claim 11, wherein the service terms include a price and acceptance of the service terms includes a payment of the price.

13. The method of claim 11, further comprising selecting the profile data from stored data indicating particular usages of televisions, telephones, mobile phones, data network interfaces, or any combination thereof, by each of the plurality of customers of the service provider.

14. The method of claim 13, wherein the stored data indicates times of the particular usages.

15. The method of claim 14, wherein the plurality of customer profile parameters includes one or more particular usages of a television, telephone, mobile phone, data network interface, or any combination thereof, during a period of time specified by the third-party, and wherein the collective customer profile information relates to customers of the service provider who have engaged in the particular usages during the specified period of time.

16. The method of claim 11, wherein the targeted content includes advertising content, public service content, emergency alert content, upsell content, sports content, or any combination thereof.

17. The method of claim 11, wherein the third-party is a customer of the service provider and the targeted content includes customer-created content.

18. The method of claim 11, wherein the request indicates that the third-party is to deliver the targeted content to customers whose profile data was used to produce the collective customer profile data.

19. The method of claim 11, further comprising not including profile data of customers that have opted out of receiving targeted content in the aggregated profile data.

20. A method of facilitating delivery of targeted content, the method comprising:
sending data to a content brokering system of a service provider, the data indicating a request to deliver targeted content to a plurality of customers of the service provider, wherein the request includes a plurality of customer profile parameters;
receiving data indicating a number of customers of the service provider whose profile data at least partially matches the plurality of customer profile parameters;
receiving service terms corresponding to the request from the service provider; and
sending the targeted content to the targeted content brokering system for delivery to the customers of the service provider whose profile data at least partially matches the plurality of customer profile parameters.

21. The method of claim 20, further comprising sending data to the service provider broker system indicating acceptance of the service terms, before or substantially concurrent with sending the targeted content.

22. The method of claim 21, wherein the service terms include a service level agreement (SLA) and acceptance of the service terms includes assent to the SLA.

23. The method of claim 22, further comprising receiving the SLA via a graphical user interface (GUI) that includes a selectable acceptance indicator, wherein the data indicating acceptance of the service terms includes data indicating a selection of the acceptance indicator.

24. A system to facilitate delivery of targeted content, the system comprising:
a content brokering engine operable to:
receive a request from a third-party to deliver targeted content to a plurality of customers of a service provider, wherein the request includes a plurality of customer profile parameters;
communicate service terms to the third-party, wherein the service terms are determined for the request based at least partially on a type of the targeted content; and
receive the targeted content from the third-party after the service provider receives data indicating acceptance of the service terms.

25. The system of claim 24, wherein the content brokering engine is operable to send data indicating the request to a service provider pricing system and to receive the service terms from the service provider pricing system, the service terms including a price, a service level agreement (SLA), or a combination thereof.

26. The system of claim 24, wherein the content brokering engine is operable to receive collective customer profile information produced from profile data of at least some of the plurality of customers of the service provider.

27. The system of claim 26, wherein the collective customer profile information is accessible to the content brokering engine at the profile aggregation system and wherein the content brokering system is operable to send data related to the collective customer profile information to the third-party with the service terms.

28. The system of claim 24, wherein the content brokering system is operable to send the targeted content to at least some of the plurality of customers of the service provider via at least one of a plurality of communication service systems of the service provider.

29. A system to facilitate delivery of targeted content, the system comprising:
a profile aggregation system operable to:
receive data from a third-party indicating a request to deliver targeted content to a plurality of customers of a service provider, wherein the request includes a plurality of customer profile parameters;
aggregate profile data associated with at least some of the plurality of customers of the service provider to produce collective customer profile information corresponding to the request, wherein the profile data matches at least some of the customer profile parameters; and
communicate service terms to the third-party, wherein the service terms are determined for the request based at least partially on a type of the targeted content.

30. The system of claim 29, wherein the profile aggregation system is operable to communicate delivery information to the third-party after the service provider receives data indicating acceptance of the service terms by the third-party, and wherein the plurality of customers are accessible to the third-party using the delivery information.

31. The system of claim 29, wherein the profile aggregation system is operable to send data related to the collective customer profile information to a content brokering system before communicating the service terms to the third-party, and wherein the data related to the collective customer profile information is accessible to the third-party via the content brokering system.

32. The system of claim 31, wherein the content brokering system is operable to receive the targeted content from the third-party after the third-party accepts the service terms.

33. The system of claim 29, wherein the service terms are based at least partially on a granularity of at least one of the customer profile parameters, a level of certainty associated with the collective customer profile information, or a combination thereof.

34. The system of claim 29, wherein the profile aggregation system is operable to send data corresponding to the request and the collective customer profile information to a negotiation system and to receive the service terms from the negotiation system.

35. A computer-readable medium including processor-readable instructions adapted to cause a processor to execute a method comprising:
receiving data from a third-party indicating a request to deliver targeted content to a plurality of customers of a service provider, wherein the request includes a plurality of customer profile parameters;
aggregating profile data associated with at least some of the plurality of customers of the service provider to produce collective customer profile information corresponding to the request, wherein the profile data matches at least some of the customer profile parameters; and
communicating service terms to the third-party, wherein the service terms are determined for the request based at least partially on a type of the targeted content.

36. The computer-readable medium of claim 35, further comprising processor-readable instructions adapted to cause the processor to send delivery information to the third-party after the service provider receives data indicating acceptance of the service terms by the third-party, wherein the plurality of customers are accessible to the third-party using the delivery information.

37. The computer-readable medium of claim 35, further comprising processor-readable instructions adapted to cause the processor to gather profile data associated with the plurality of customers, the profile data including data related to particular usages of televisions, telephones, mobile phones, data network interfaces, or any combination thereof, by each of the plurality of customers.

38. The computer-readable medium of claim 35, further comprising processor-readable instructions adapted to cause the processor to gather the profile data associated with the plurality of customers in approximately real-time.

39. The computer-readable medium of claim 35, wherein the service terms include a per customer price, a total price, or a combination thereof.
